(19) United States
(12) Patent Application Publication
(10) Pub. No.: US 2011/0057881 A1
(43) Pub. Date: Mar. 10, 2011

(54) KVM MANAGEMENT SYSTEM AND METHOD OF PROVIDING ADAPTABLE SYNCHRONIZATION SIGNAL

(75) Inventors: HONG-TAO WEN, Richmond (CA); YUN-SONG GOU, Richmond (CA); QIAN-QI ZHUANG, Richmond (CA)

(73) Assignee: ATEN INTERNATIONAL CO., LTD., Taipei (TW)

(21) Appl. No.: 12/554,176

(22) Filed: Sep. 4, 2009

(51) Int. Cl. G06F 3/02; G06F 3/033

(52) U.S. Cl. 345/163; 345/168

(57) ABSTRACT

Disclosed is a KVM management system and method of providing synchronization signal adaptable depending one user's demand. The KVM management system includes a first module and a second module. The first module converts a first type of synchronization signal selected from a first group of synchronization signal combinations into a transitional signal. The second module converts the transitional signal into a second type of synchronization signal selected from a second group of synchronization signal combinations for the display. The transitional signal may be a composite synchronization signal combines one of red, green, blue video signals from the computer and carried on at least one pair of wire in an Ethernet network cable. The type of transitional signal can be predetermined by adjusting a first register stored in the first module. The second type of synchronization signal can be predetermined by adjusting a second register stored in the second module.

### BACKGROUND OF THE INVENTION

1. Field of the Invention

The present invention generally relates to a KVM (keyboard-video-mouse) management system, and more particularly, to a KVM management system and method of providing an adaptable synchronization signal.

2. Description of Prior Art

A KVM management system allows a user of a KVM apparatus to access at least one computer coupled therewith through a console device. The console device can be a combination of a keyboard, a display and a mouse. Alternatively, the console device can further include a computer coupled to the KVM apparatus via a network. Moreover, the KVM management system can also be established in a form of a KVM extender having a local and a remote module, which are used to extending transmission distance of the keyboard-video-mouse signals between the computer and the console. Accordingly, as referring to the KVM management system, KVM switches, KVM extenders, matrix KVM switches or the likes can be illustrated.

Please refer to FIG. 1, which depicts U.S. Pat. Appl. Pub. 2006/0227244 (commonly owned as the present application) disclosing a circuit diagram of a KVM management system for pre-processing the synchronization signal from the computer. In the KVM-like products at present, once the synchronization signal of the video signal from the computer is going to be processed, the hardware solution is introduced for processing generally. As shown in FIG. 1, the hardware solution constructs a complicated electric circuit with ICs, resistances, capacitors, multiplexers, logic combination gates, select circuits and etc. All components are pure-hardware and the circuit design must be complicated. Moreover, such kind of hardware solution can merely deal with specific type of synchronization signal and output just one specific type of synchronization signal only. Inconveniently, the aforesaid types had to be decided when the KVM-like products is designed before manufacture and cannot be changed after the products are manufactured. Furthermore, such kind of hardware circuit has to be adjusted for fitting the synchronization signal in manufacture. The hardware solution for processing the synchronization signal cannot be omitted in prior arts and therefore, the manufacture costs of all the related components exist.

Moreover, there are at least ten types of synchronization signals existing for all kinds of displays according to what is known in this field. With the property of outputting the specific type of synchronization signal only, there is the possibility that some displays may not recognize the specific type of synchronization signal successfully and in turn cannot work with the KVM-like products.

### SUMMARY OF THE INVENTION

Consequently, there is a need to develop a KVM management system which allows an adaptable synchronization signal provided and suitable for all kinds of displays. An objective of the present invention is to provide a KVM management system capable of providing an adaptable synchronization signal for the display coupled with the KVM management system.

Another objective of the present invention is to provide a KVM management system coupling a computer to a display. The KVM management system can analyze the synchronization signal from the computer and provide an adaptable type of synchronization signal for kinds of the display.

The KVM management system of according to embodiments of the present invention includes a first module and a second module and can couple a computer to a display, a keyboard and a mouse located remotely. The first module converts a first type of synchronization signal selected from a first group of synchronization signal combinations into a transitional signal. The second module converts the transitional signal into a second type of synchronization signal selected from a second group of synchronization signal combinations for the display. The first type of synchronization signal may be different form the second type of synchronization signal. Alternatively, the first type of synchronization signal can be the same as the second type of synchronization signal. The first module or the second module is a programmable logic device. The transitional signal may be a composite synchronization signal, which further combines one of red, green, blue video signals from the computer and carried on at least one twisted wire pair of an Ethernet network cable between the first and the second modules. Alternatively, the transitional signal can be a non-composite synchronization signal, which further combines two of red, green, blue video signals from the computer and carried on at least two twisted wire pairs of an Ethernet network cable between the first and the second modules. There is a chance that the first type of synchronization signal may be not acceptable for the display, but with embodiments of the present invention, the second type of synchronization signal can be converted to be acceptable for the display. Therefore, embodiments of the present invention enable the computer to control the display normally. The first module further decodes (analyzes and takes apart) the first type of synchronization signal to derive a positive horizontal synchronization component and a positive vertical synchronization component for the first time; and then encodes (re-assembles and/or reverses) the positive horizontal synchronization component and the positive vertical synchronization component for the first time to derive the transitional signal. The second module further decodes (analyzes and takes apart) the transitional signal to derive a positive horizontal synchronization component and a positive vertical synchronization component for the second time; and then encodes (re-assembles and/or reverses) the positive horizontal synchronization component and the positive vertical synchronization component for the second time to derive the second type of synchronization signal.

The type of transitional signal can be predetermined by adjusting a first register stored in the first module as well as the second type of synchronization signal can be predetermined by adjusting a second register stored in the second module. The first group of synchronization signal combinations or the second group of synchronization signal combinations can be a group consisting of a positive horizontal synchronization signal plus a positive vertical synchronization signal, a positive horizontal synchronization signal plus a negative vertical synchronization signal, a negative horizontal synchronization signal plus a positive vertical synchronization signal, a negative horizontal synchronization signal plus a negative vertical synchronization signal, a negative composite horizontal and vertical synchronization signal plus a positive vertical synchronization signal, a positive composite horizontal and vertical synchronization signal without vertical synchronization signal, a negative composite horizontal and vertical synchronization signal without vertical synchronization signal, a positive composite horizontal and vertical synchronization signal plus a positive vertical synchronization signal, a negative composite horizontal and vertical synchronization signal plus a negative vertical synchronization signal and a positive composite horizontal and vertical synchronization signal plus a negative vertical synchronization signal.

Accordingly, embodiments of the present invention allow the console user of the KVM management system to control computer power directly in an easy and cheap way than well known prior arts.

### BRIEF DESCRIPTION OF THE DRAWINGS

FIG. 1 depicts a circuit diagram of a KVM management system for processing the synchronization signal from the computer according to prior arts.

FIG. 2 depicts a functional block diagram of the KVM management system according to the first embodiment of the present invention.

FIG. 3 depicts a functional block diagram of the KVM management system according to the second embodiment of the present invention.

FIG. 4A depicts a detail diagram of the computer side module of the KVM management system of FIG. 3.

FIG. 4B depicts a detail diagram of the user side module of the KVM management system of FIG. 3.

FIG. 4C depicts a simplified adaptable diagram relating to FIGS. 4A and 4B.

FIG. 5A and FIG. 5B show ten types of the synchronization signal combinations.

FIG. 6 depicts a flow chart of the decoding process of the method of providing an adaptable synchronization signal according to an embodiment of the present invention.

FIG. 7 depicts a flow chart of the encoding process of method of providing an adaptable synchronization signal according to an embodiment of the present invention.

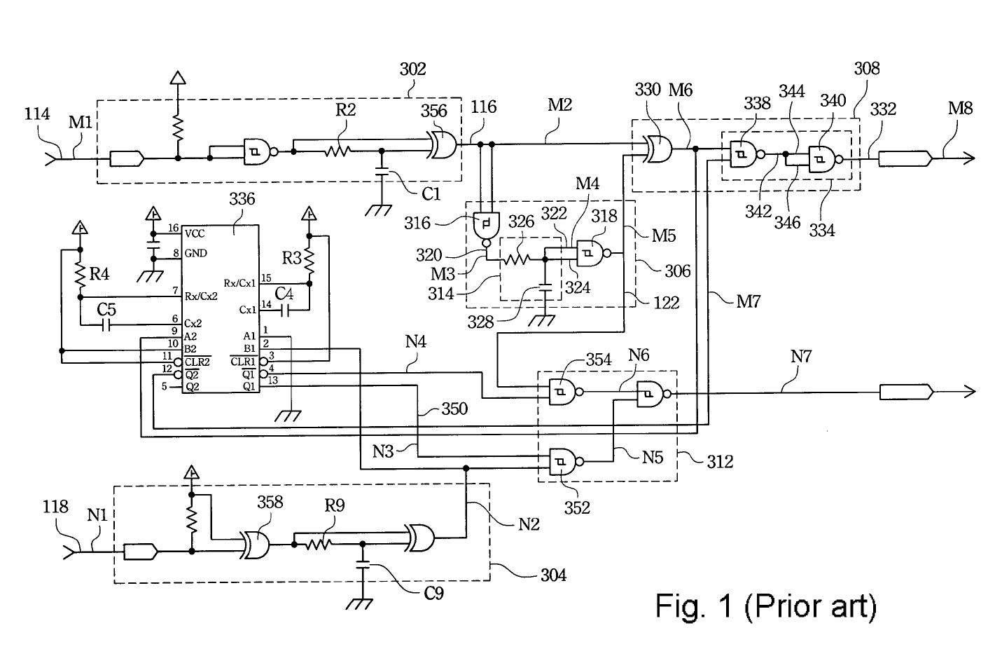

### DETAILED DESCRIPTION OF THE INVENTION

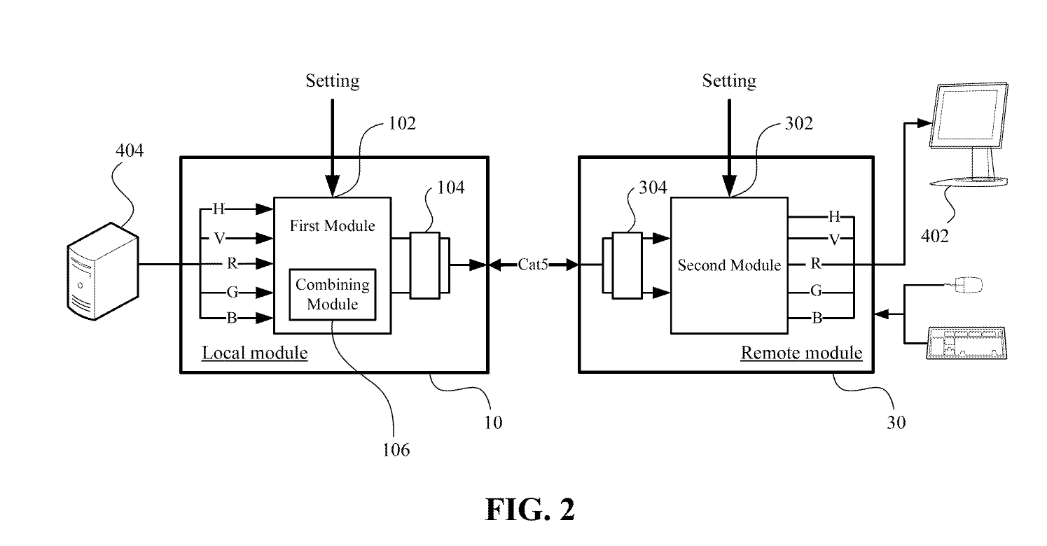

Please refer to FIG. 2, which depicts a functional block diagram of the KVM extender system according to the first embodiment of the present invention. In this embodiment, the KVM extender system includes a local module 10 and a remote module 30. The KVM extender system couples a computer 404 to a display 402 and a set of keyboard and a mouse (console device) such that the console device is able to manipulate the computer 404 remotely. The local module 10 and the remote module 30 are connected with a CAT-5 cable. The local module 10 includes a first module 102, a first interface 104. The first module 102 further includes a combining module 106. The remote module 30 includes a second module 302 and a second interface 304. The first interface 104 or the second interface 304 may include a RJ-45 connector for connecting a CAT-5 cable, respectively.

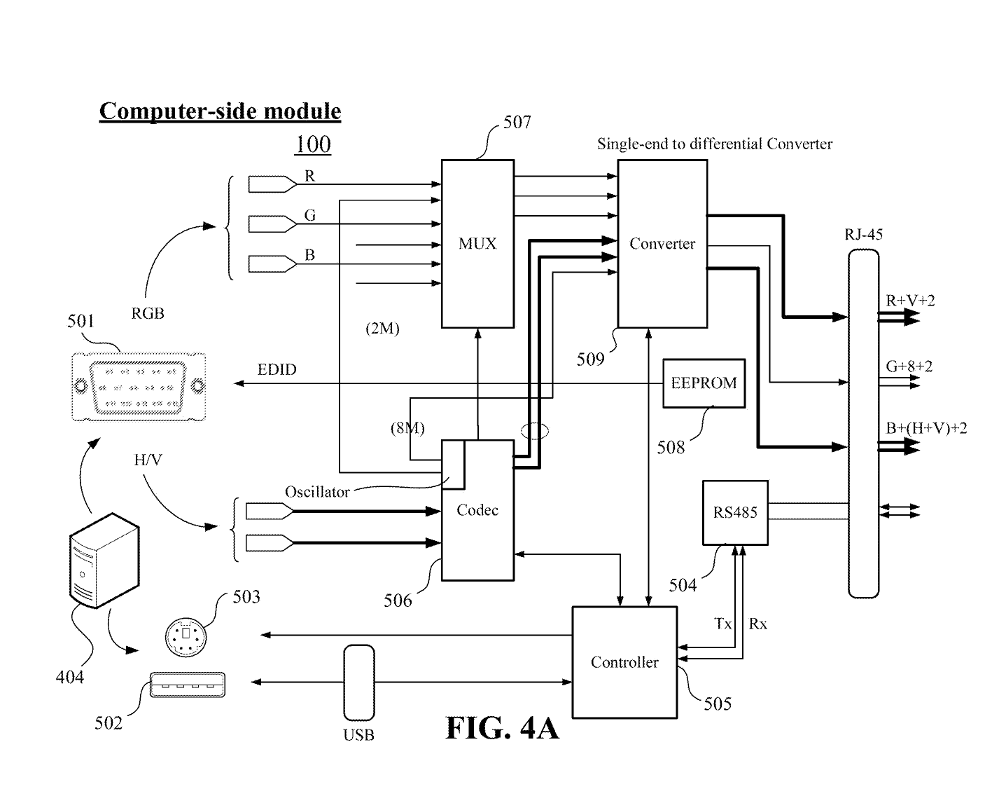

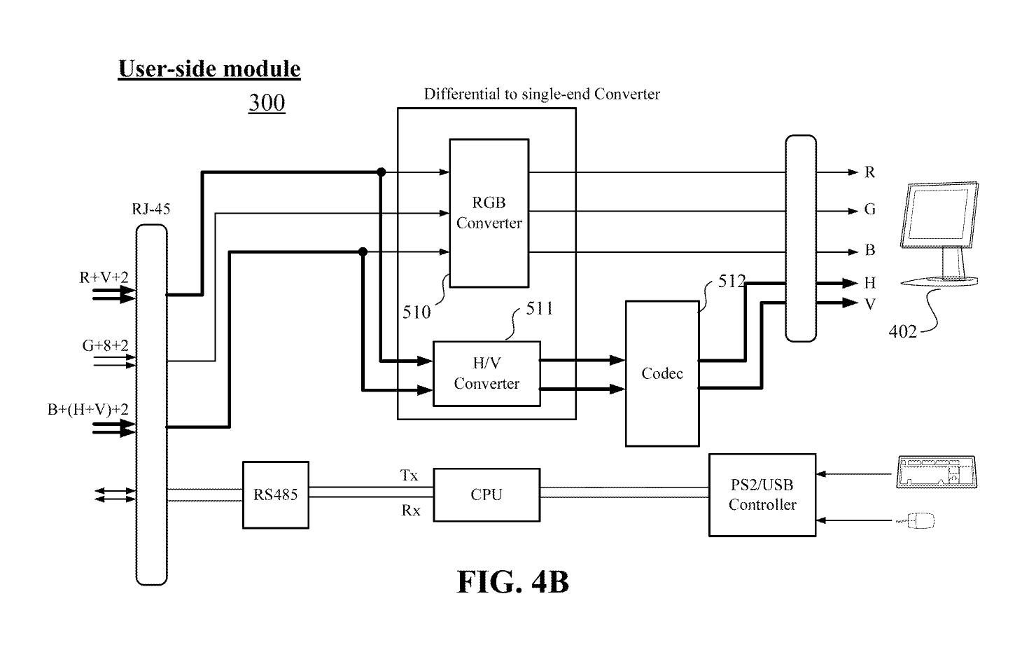

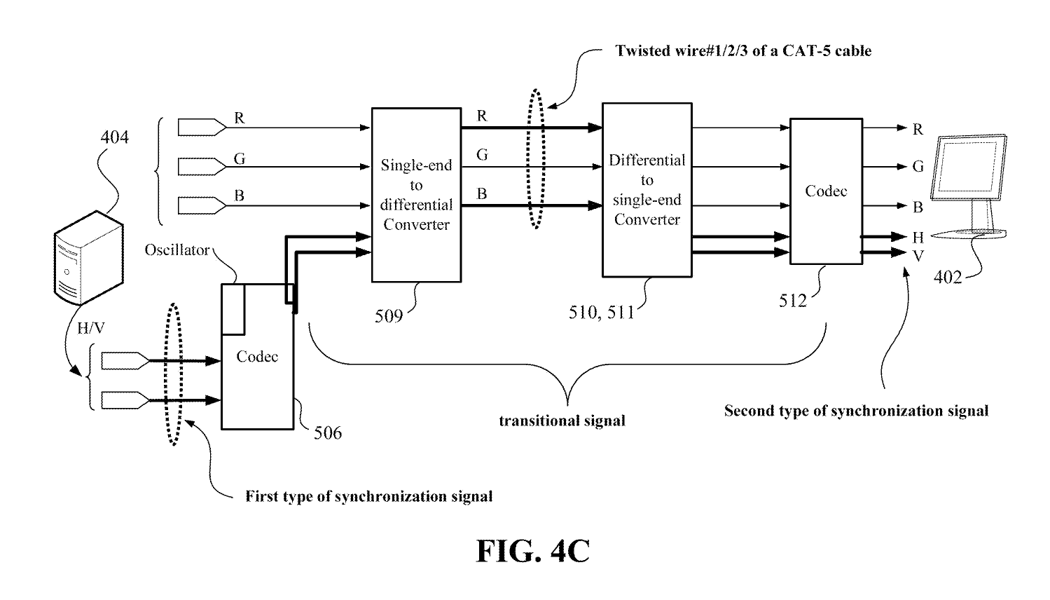

As shown in FIG. 2, the first module 102 of the local module 10 receives the red, green, blue video signal R, G, B as well as the horizontal synchronization signal H and the vertical synchronization signal V from the computer 404. The first module 102 converts a first type of synchronization signal into a transitional signal. Then, the transitional signal is transmitted to the remote module 30 through the CAT-5 cable. The second module 302 converts the transitional signal into a second type of synchronization signal for the display 402. In one preferred embodiment, the first module 102 and the second module 302 are implemented by programmable logic devices, such as FPGA, CPLD, DSP, ASIC, SOC and etc. The transitional signals represent the outputted signals of the Codec 506, the Converter 509 and the Converters 510,511 (described in more detail later with reference to FIGS. 4A and 4B). That is, the transitional signals can be the converted first type of synchronization signal outputted by Codec 506 combined with the red, green, blue video signal R, G, B from the computer 404, which are carried on three twisted wire pairs of the CAT-5 cable.

As shown in FIG. 2, the type of transitional signal outputted by the first module 102 can be predetermined by adjusting a first register stored in the first module 102. The second type of synchronization signal can be predetermined by adjusting a second register stored in the second module 302. Alternatively, the type of transitional signal outputted by the first module 102 can be determined on the user's demand at any time.

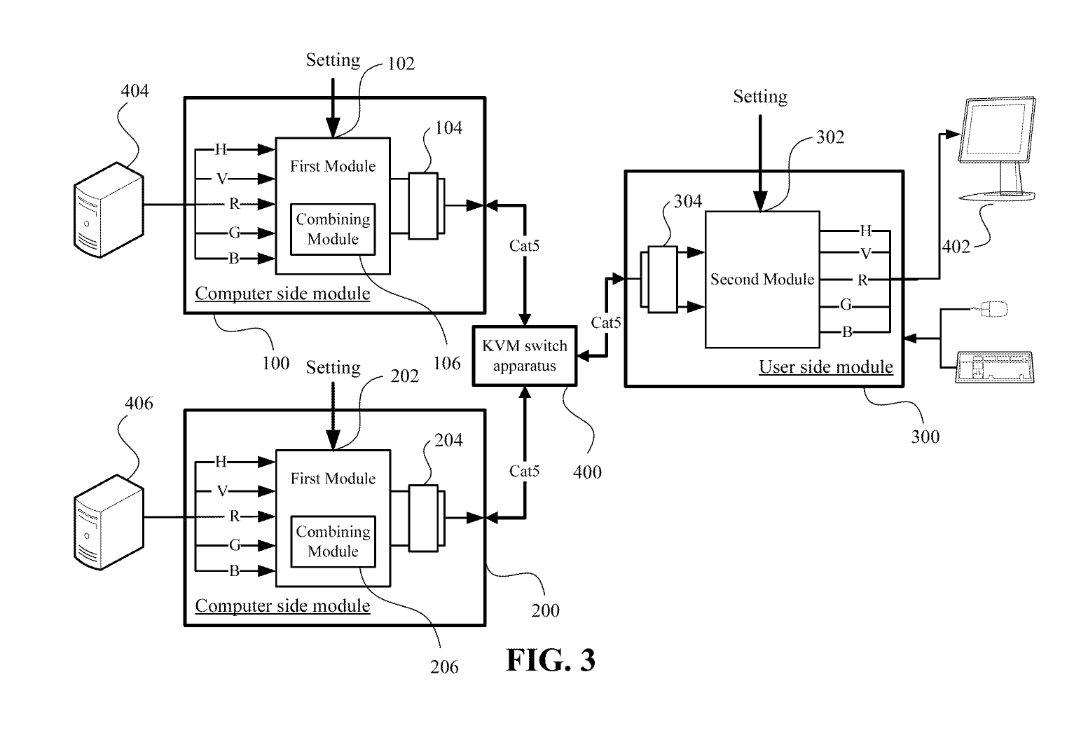

Please refer to FIG. 3, which depicts a functional block diagram of a KVM management system according to the second embodiment of the present invention. In this embodiment, the KVM management system includes a plurality of computer-side modules 100, 200, at least one user-side module 300 and a KVM switch apparatus 400. The KVM management system couples computers 404, 406 to a display 402 and a set of keyboard and a mouse (a set of console device). The CAT-5 cables are utilized for connecting the computer side modules 100, 200, the user-side module 300 and the KVM switch apparatus 400. The KVM switch apparatus 400 routes control signals from the keyboard or the mouse to the computer 404 or computer 406 such that the console device is able to manipulate the computer 404 or computer 406 remotely. On the other hand, the KVM switch apparatus 400 routes video signals from the computer 404 or 406 in response to the aforesaid control signals to the display 402 according to a path setting performed by a set of Hot-Key commands or an OSD menu. The computer-side module 100 further includes a first module 102, a first interface 104. The first module 102 further includes a combining module 106. Likewise, the computer-side module 200 includes a first module 202, a first interface 204. The first module 202 further includes a combining module 206. The user-side module 300 includes a second module 302 and a second interface 304. Similar described as the first embodiment shown in FIG. 2, the type of transitional signal outputted by the first modules 102, 202 can be predetermined by adjusting the first registers stored in the first module 102, 202. The second type of synchronization signal can be predetermined by adjusting the second register stored in the second module 302.

As shown in FIG. 3, the first module 102 of the computer-side module 100 receives the red, green, blue video signal R, G, B as well as the horizontal synchronization signal H and the vertical synchronization signal V from the computer 404. The first module 202 of the computer-side module 200 receives the video signal R, G, B as well as the horizontal synchronization signal H and the vertical synchronization signal V from the computer 406. The first module 102, 202 can convert a first type of synchronization signal from the computers 404, 406 into transitional signals. The transitional signals are routed by the KVM switch apparatus 400 and transmitted to the user-side module 300 through the CAT-5 cables and the KVM switch apparatus 400. Then, the second module 302 converts a selected one of the transitional signals into a second type of synchronization signal for the display 402. The transitional signals represent the outputted signals of the Codec 506, the Converter 509 and the Converters 510,511 (described in more detail later with reference to FIGS. 4A and 4B). That is, the transitional signals can be the converted first type of synchronization signal outputted by Codec 506. The transitional signals can be the signals including the horizontal synchronization signal H and the vertical synchronization signal V combined with the red, green, blue video signal R, G, B, which are carried on three twisted wire pairs of the CAT-5 cable.

Via the KVM switch apparatus 400, an user at the console device having the display 402 can selectively access the computers 404, 406 with the keyboard, the mouse. Meanwhile, the user can see his operations through the display 402 by receiving the video signals from the computer 404 or 406. Specifically, the combining modules 106 and 206 shown in FIG. 2 and FIG. 3 respectively are both employed for combining the synchronization signals H, V from the Codecs with one of red, green, blue video signals from the computer 404 and 406. More details will be described later. On the other hand, control signals from the keyboard and the mouse are transmitted to the selected computer 404 or 406 via the KVM switch apparatus 400 according to a path setting performed by hot-key commands or an OSD menu. Please note that, in one preferred embodiment, the user-side module 300 may be included in the same housing with the KVM switch apparatus 400. That is, the KVM switch apparatus 400 includes the second module 302. The KVM switch apparatus 400 also includes other components well-known in the art, such as a processor, a cross-point switch for routing the above-mentioned signals.

Please refer to FIGS. 4A, 4B and 4C. FIG. 4A depicts a detail diagram of a computer-side module 100 or 200 of the KVM management system shown in FIG. 3 according to an embodiment of the present invention. FIG. 4B depicts a detailed diagram of a user-side module 300 of the KVM management system shown in FIG. 3 according to an embodiment of the present invention. FIG. 4C depicts a simplified diagram related with the FIG. 4A and FIG. 4B according to an embodiment of the present invention. For example, the computer-side module 100 in FIG. 4A receives the red, green, blue video signals with the horizontal synchronization signal H and the vertical synchronization signal V from the computer 404 through a VGA interface 501. Meanwhile, the computer-side module 100 also transmits control signals from the keyboard or mouse of the console device manipulating the computer remotely to the computer 404 through a USB interface 502 or a PS/2 interface 503. The control signals form the keyboard or the mouse located remotely are received by a RS-485 transceiver 504, and then the control signals are sent to a controller 505 for parsing and coding. After that, the control signals are sent to a keyboard or a mouse port of the computer 404. Meanwhile, a USB-related signal, command or data for virtual media function from the user-side module 300 is also received by the RS-485 transceiver 504, and then the USB-related signal, command or data is sent to a USB port of the computer 404. The synchronization signals H, V are processed with the Codec 506 in the computer-side module 100 having an oscillator shown in FIG. 4A. Optionally, the oscillator can provide a first test signal, such as a square wave with 2 MHz frequency for skew compensation, and a second test signal, such as a square wave with 8 MHz frequency for detecting the length of the CAT-5 cable or the attenuation between the computer-side module 100 and the user-side module 300, respectively. For the skew compensation in the user-side module 300, the first test signal is combined into the red, green, blue video signals and then outputted to the converter 509 by a MUX 507. The EDID of the display 402 shown in FIG. 3 can be temporally saved in the EEPROM 508 and sent for later. In one embodiment, the Codec 506 can be implemented by programmable logic devices, such as FPGA, CPLD, DSP, ASIC, SOC and etc.

The red, green, blue video signals with or without the first test signal, the second test signal as well as the horizontal synchronization signal H, and the vertical synchronization signal V are transferred to the converter 509 (such as a single-end to differential converter). In one embodiment, the converter 509 includes an operational amplifier. The converter 509 combines the horizontal synchronization signal H and the vertical synchronization signal V with or without the first test signal, the second test signal as well as the red, green, blue video signals into a transitional signal in differential mode. Then, the transitional signal is carried on at least one (up to three) twisted wire pair in the CAT-5 cable (i.e. an Ethernet network cable having four twisted wire pairs connected with the RJ-45 shown in FIG. 4A) and transmitted to the user-side module 300. In this embodiment, a synchronization signal combination, the composite horizontal and vertical signal (H+V) plus a vertical synchronization signal V, is illustrated. The positive composite horizontal and vertical signal (H+V) is carried with the blue video signal. The positive vertical synchronization signal V is carried with the red video signal.

Then, as shown in FIG. 4B, the user-side module 300 receives the transitional signal, i.e. the aforesaid synchronization signal combination. The red, green, blue video signals are extracted by a RGB converter 510 (such as a differential to single-end converter) from the transitional signal. The composite horizontal and vertical signal (H+V) plus a vertical synchronization signal V are extracted by a H/V converter 511 from the transitional signal before entering a Codec 512. Then, the Codec 512 in the user-side module 300 processes the composite horizontal and vertical signal (H+V) plus a vertical synchronization signal V, and provide the second type of synchronization signal combination to the display 402.

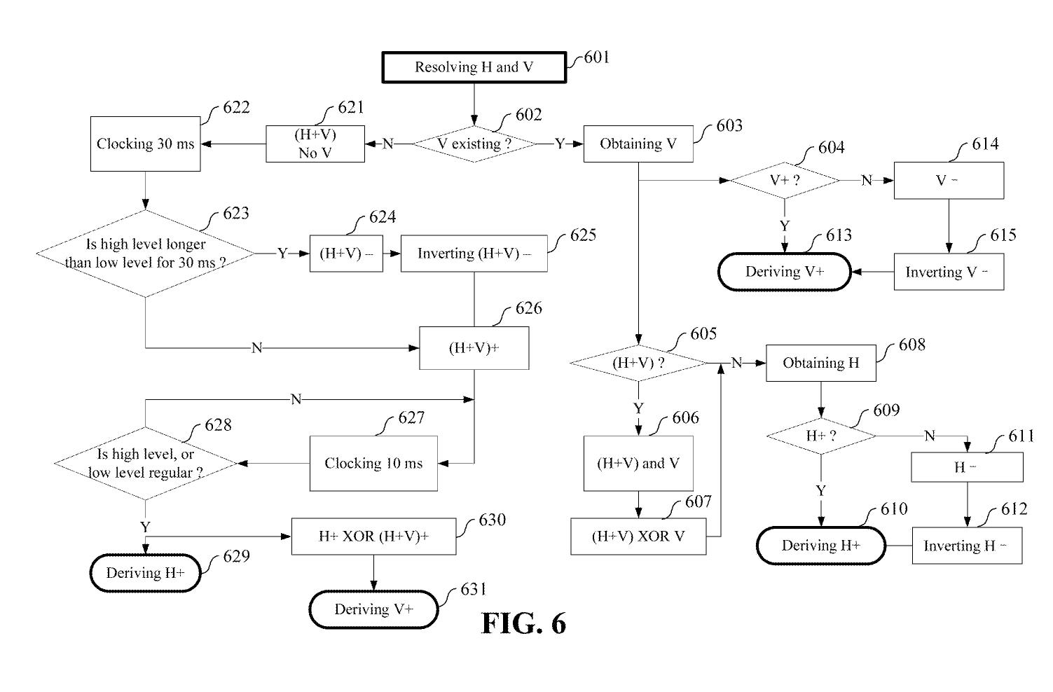

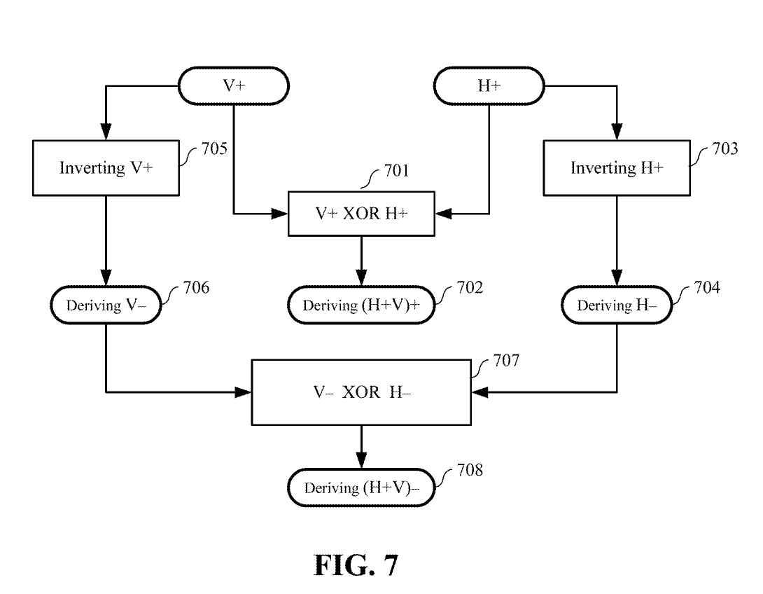

Please refer to FIG. 4C, which depicts a simplified diagram related with the FIG. 4A and FIG. 4B. In one embodiment, the horizontal synchronization signal H and the vertical synchronization signal V from the computer 404 is the first type of the synchronization signal, e.g. the combination 1 shown in Table 1. Then, R, G and B signals from the computer as well as the converted first type of the synchronization signals from the Codec 506 are inputted into the converter 509. With the KVM management system of the present invention, the R, G and B signals as well as the converted first type of the synchronization signal can be converted into the transitional signal for transmission between the first module 102 and the second module 302 shown in FIG. 3 by the process described with reference to FIGS. 6 and 7 in more detail later. After the transitional signal is received, the second module 302 converts the transitional signal into the second type of the synchronization signal, e.g. the combination 2 in Table 1 for the requirement of the display 402 by the process described with reference to FIGS. 6 and 7 in more detail later. Both the first module 102 in the computer-side module 100 (or the local module 10) and the second module 302 in the user-side module 300 (or the remote module 30) can be programmable logic devices, such as FPGA, CPLD, DSP, ASIC, SOC and etc. Because the aforesaid decoding and encoding processes are executed in digital format, therefore, by adjusting the first register in the first module and the second register in the second module, all of the first type of the synchronization signal, the transitional signal and the second type of the synchronization signal can be changed easily as demand and not restricted by the hardware design. Significantly, the hardware solution according to prior arts can be erased and the necessary adjustment for fitting the synchronization signal can be omitted, either. The related manufacture costs disappear.

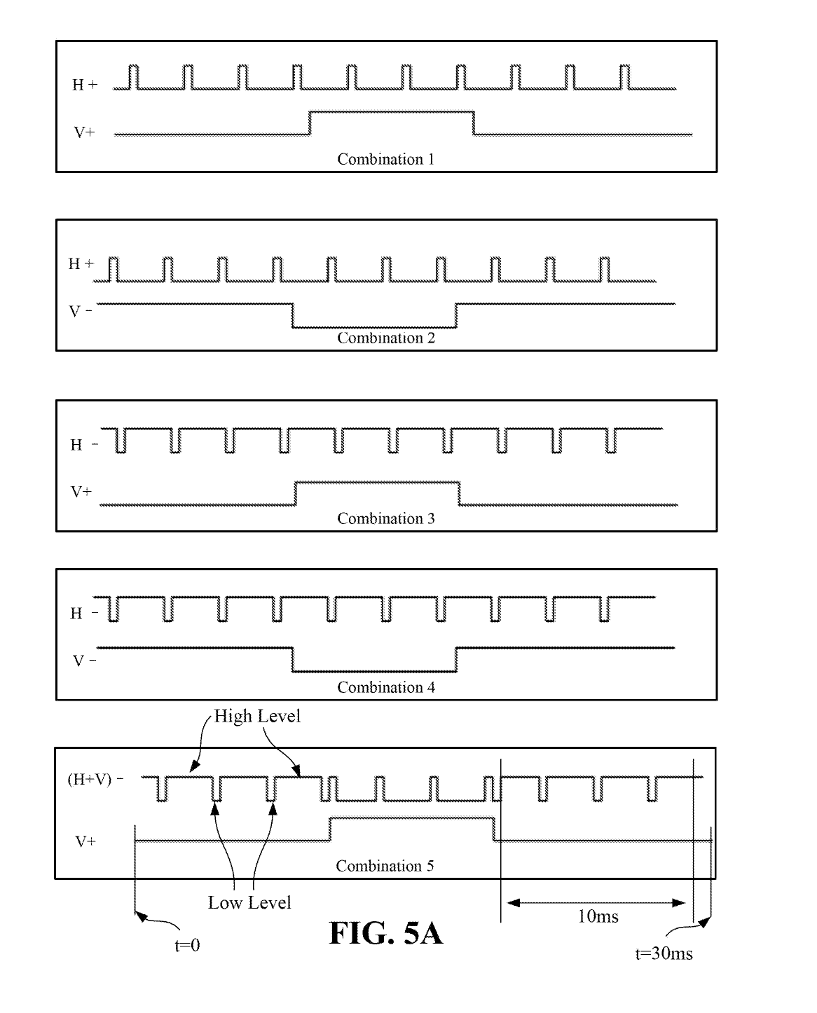

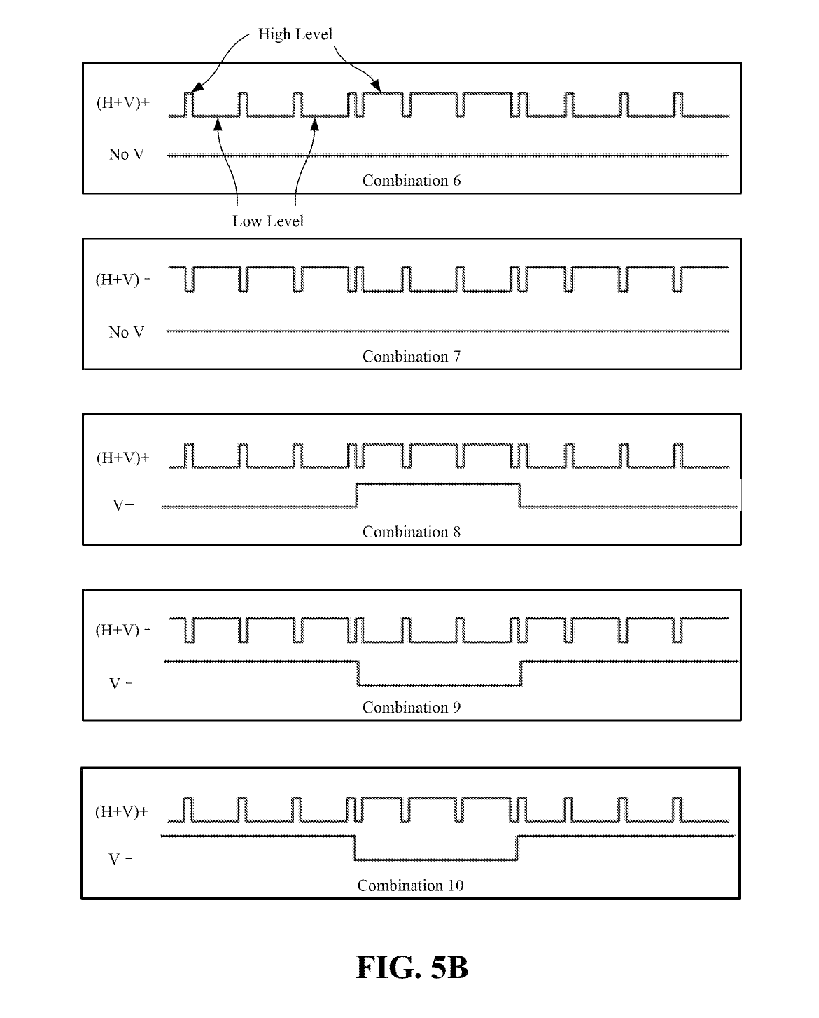

Please refer to Table 1 below with FIG. 5A and FIG. 5B which show ten types of the synchronization signal combinations. The Table 1 are the content list of ten types of H/V synchronization signal combinations existing for various kinds of displays according to what is known in this field as aforementioned. FIG. 5A and FIG. 5B show the waveforms of the ten types of H/V synchronization signal combinations correspondingly. In one preferred embodiment, the aforementioned first type of synchronization signal is selected from the combinations show in Table 1. The aforementioned second type of synchronization signal is also selected from the combinations show in Table 1. However, the first type and the second type can be different or the same. For example, the first type of synchronization signal is the combination 1, and the second type of synchronization signal is the combination 2. Please note that there may be other types of synchronization signal combinations according to VESA standard. Therefore, the present invention is not limited to the ten types of H/V synchronization signal combinations shown in FIG. 5A and FIG. 5B. As shown in FIG. 5A and FIG. 5B, the combinations 1 to 4 indicate that the horizontal synchronization signal H and the vertical synchronization signal V are carried on separate wires or channels between the computer and the first module at first. After being processed by the first module, the combinations 1 to 4 can represent the horizontal synchronization signal H and the vertical synchronization signal V carried on separate twisted wire pairs of the Cat5 cable between the first module and the second module. The combinations 5, 8 to 10 indicate that the horizontal synchronization signal H and the vertical synchronization signal V are carried on the same wire or channel between the computer and the first module at first. Meanwhile, the combinations 5, 8 to 10 also indicate that the vertical synchronization signal V is carried on another wire or channel between the computer and the first module. After being processed by the first module, the combinations 5, 8 to 10 can represent the horizontal synchronization signal H and the vertical synchronization signal V carried on the same twisted wire pair of the Cat5 cable between the first module and the second module. In the meantime, the combinations 5, 8 to 10 also represent that the vertical synchronization signal V is carried on another twisted wire pair of the Cat5 cable between the first module and the second module. The combinations 6 and 7 indicate that the horizontal synchronization signal H and the vertical synchronization signal V are carried on the same wire or channel between the computer and the first module at first. However, the combinations 6 and 7 also indicate that the vertical synchronization signal V is not present on the other wires or channels between the computer and the first module. After being processed by the first module, the combinations 6 and 7 can represent the horizontal synchronization signal H and the vertical synchronization signal V carried on the same wire or channel between the first module and the second module. Moreover, the combinations 6 and 7 also represent that the vertical synchronization signal V is not present on the other wires or channels between the first module and the second module.

TABLE 1
Content List of Ten types H/V combinations

| | |
|---|---|
| Combination 1 | positive horizontal synchronization signal |
| | plus positive vertical synchronization signal |
| Combination 2 | positive horizontal synchronization signal |
| | plus negative vertical synchronization signal |
| Combination 3 | negative horizontal synchronization signal |
| | plus positive vertical synchronization signal |
| Combination 4 | negative horizontal synchronization signal |
| | plus negative vertical synchronization signal |
| Combination 5 | negative composite horizontal |
| | and vertical synchronization signal |
| | plus positive vertical synchronization signal |
| Combination 6 | positive composite horizontal and |
| | vertical synchronization signal |
| | without vertical synchronization signal |
| Combination 7 | negative composite horizontal and |
| | vertical synchronization signal |
| | without vertical synchronization signal |
| Combination 8 | positive composite horizontal and |
| | vertical synchronization signal |
| | plus positive vertical synchronization signal |
| Combination 9 | negative composite horizontal and |
| | vertical synchronization signal |
| | plus negative vertical synchronization signal |
| Combination 10 | positive composite horizontal and |
| | vertical synchronization signal |
| | plus negative vertical synchronization signal |

Please refer to FIG. 6, which depicts a flow chart of the decoding process of the method of providing an adaptable synchronization signal according to the present invention. The flow chart show in FIG. 6 can be performed by the Codec 506 shown in FIG. 4A or the Codec 512 shown in FIG. 4B. Basically, the decoding process of the method of providing an adaptable synchronization signal comprises steps of:

converting a first type of synchronization signal from a computer selected from a first group of synchronization signal combinations into a transitional signal by a first module; and

combining one of red, green, blue video signals from the computer with the transitional signal.

During the converting step, a step of adjusting a first register stored in the first module can be further included to change the first type of synchronization signal. The Detail decoding process is introduced below:

Step 601, Starting for resolving the inputted synchronization signal H, V from the computer;

Step 602, determining if V component exists; if yes, then proceeding Step 603; if no, proceeding Step 621;

Step 603, obtaining the V component of the synchronization signal; then proceeding Step 604 and Step 605 simultaneously;

Step 604, determining if the V component is a positive vertical synchronization signal V+; if yes, then proceeding Step 613; if no, proceeding Step 614;

Step 605, determining if the inputted synchronization signal is a composite synchronization signal (H+V); if yes, then proceeding Step 606; if no, proceeding Step 608;

Step 606, determining if the inputted synchronization signal is the composite synchronization signal (H+V) and V component;

Step 607, if “Yes” in Step 606, processing a Boolean operation of (H+V) XOR V;

Step 608, obtaining H component;

Step 609, determining if the H component is a positive horizontal synchronization signal H+; if yes, then proceeding Step 610; if no, proceeding Step 611;

Step 610, if “Yes” in Step 609, deriving the positive horizontal synchronization signal H+;

Step 611, if “No” in Step 609, obtaining the negative horizontal synchronization signal H−;

Step 612, inverting the negative horizontal synchronization signal H− and backing to Step 610;

Step 613, deriving the positive vertical synchronization signal V+;

Step 614, obtaining the negative vertical synchronization signal V−;

Step 615, inverting the negative vertical synchronization signal V− and backing to Step 613

Step 621, determining if the inputted synchronization signal is a positive composite synchronization signal (H+V) without the vertical synchronization signal V;

Step 622, activating the timer of the first module for clocking a first time period, such as 30 ms;

Step 623, determining if the high level is longer than the low level for 30 ms; if yes, then proceeding Step 624; if no, proceeding Step 626;

Step 624, determining that the inputted synchronization signal is a negative composite synchronization signal (H+V)−;

Step 625, inverting the negative composite synchronization signal (H+V)−;

Step 626, obtaining the composite synchronization signal (H+V)+;

Step 627, activating the timer of the first module for clocking a second time period, such as 10 ms;

Step 628, determining if the interval for each high level or each low level is regular during this time period of 10 ms; if yes, then proceeding Step 629 and Step 630; if no, repeating Step 627 and Step 628;

Step 629, deriving the positive horizontal synchronization signal H+;

Step 630, processing a Boolean operation of H+ XOR (H+V)+; and

Step 631, deriving the positive vertical synchronization signal V+.

In conclusion, the first module decodes (analyzes and takes apart) the first type of synchronization signal to derive a positive horizontal synchronization component H+ and a positive vertical synchronization component V+ for the first time; and then encodes (re-assemble and/or inverses) the positive horizontal synchronization component and the positive vertical synchronization component for the first time to derive the transitional signal selected from Table 1. If needed, the second module also decodes (analyzes and takes apart) the transitional signal to derive a positive horizontal synchronization component and a positive vertical synchronization component for the second time; and then encodes (re-assembles and/or inverses) the positive horizontal synchronization component and the positive vertical synchronization component for the second time to derive the second type of synchronization signal selected from Table 1. The high level means a time interval from a rising edge to a next falling edge. The low level means a time interval from a falling edge to a next rising edge. For example, in Step 623, the waveform of Combination 5 shown in FIG. 5A indicates that accumulated intervals of high levels are higher than those of low levels, so that the first module 102 or the second module 302 can determine that the inputted synchronization signal is a negative composite synchronization signal (H+V)−. On the other hand, the waveform of Combination 6 shown in FIG. 5B indicates that accumulated intervals of low levels are higher than those of high levels, so that the first module 102 or the second module 302 can determine the inputted synchronization signal is a positive composite synchronization signal (H+V)+. The “regular” in Step 628 means that the interval for each high level is the same, or the interval for each low level is the same in a period of time. For example, in Step 628, as shown in FIG. 5A, the last ⅓ portion of the waveform indicates that the interval for each high level or each low level is regular. However, as shown in FIG. 5A, the former ⅔ portion of the waveform indicates that the interval for each high level or each low level is not regular. Therefore, the former ⅔ portion of the waveform is neglected, and the process goes to Step 627 again.

Significantly, the complete detail decoding process definitely can derive the positive horizontal synchronization signal H+ and the positive vertical synchronization signal V+. Similarly, other nine types of the synchronization signals can also be derived from the aforesaid decoding process of the method for providing an adaptable synchronization signal according, to the present invention.

Please refer to FIG. 7, which depicts a flow chart of the encoding process of method of providing an adaptable synchronization signal. The flow chart show in FIG. 7 can be performed by the Codec 506 shown in FIG. 4A or the Codec 512 shown in FIG. 4B. Basically, the encoding process of method of providing an adaptable synchronization signal comprises a step of: converting the transitional signal into a second type of synchronization signal selected from a second group of synchronization signal combinations for the display by a second module. During the converting step, a step of adjusting a second register stored in the second module can be further included to change the second type of synchronization signal. As aforementioned, the first module transmits the transitional signal to the second module. The second module can have the information of the positive horizontal synchronization signal H+ and positive vertical synchronization signal V+ definitely.

For providing the required type of synchronization signal for the display, the second module now is going to covert the transitional signal into the second type of the synchronization signal, i.e. the type required for the display. The a complete detail decoding process is introduced below based on the H+ and V+ derived from the transitional signal:

Step 701, processing a mathematical operation of V+ XOR H+;

Step 702, deriving the positive composite synchronization signal (H+V)+;

Step 703, inverting the positive horizontal synchronization signal H+;

Step 704, deriving the negative horizontal synchronization signal H−;

Step 705, inverting the positive vertical synchronization signal V+;

Step 706, deriving the negative vertical synchronization signal V−;

Step 707, processing a mathematical operation of V− XOR H−; and

Step 708, deriving the negative composite synchronization signal (H+V)−.

Significantly, the complete detail encoding process does not have to run through all the time. Depending on what type of the synchronization signal the display requires, the decoding process definitely can provide the demanded type of the synchronization signal for the display. For example, for providing the type of combination 1 listed in table 1, decoding process wouldn't have to be activated. For providing the type of combination 4 listed in table 1, Step 703, Step 704, Step 705 and Step 706 will be necessary. For providing the type of combination 7 listed in table 1, Step 703, Step 704, Step 705, Step 706, Step 707 and Step 708 will be necessary. For providing the type of combination 10 listed in table 1, Step 701, Step 702, Step 705 and Step 706 will be necessary. Furthermore, in another embodiment of the present invention, the transitional signal also can be another type of synchronization signal different from the first and second types.

Although, the decoding process and encoding process as aforementioned illustrate that the transitional signal is transmitted with the information of the positive horizontal synchronization signal H+ and positive vertical synchronization signal V+, which is not a limitation of the present invention. The transitional signal can be defined to carry the information of any type of the synchronization signal and transmitted from the first module to the second module. Through picking up the corresponding, required steps in the encoding process, the second module still can derive any type of synchronization signal for the demand of the display.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A keyboard-video-mouse (KVM) management system, coupling a computer to a console device having a display, comprising:
a first module, converting a first type of synchronization signal from the computer, selected from a first group of synchronization signal combinations into a transitional signal; and
a second module, converting the transitional signal into a second type of synchronization signal selected from a second group of synchronization signal combinations for the display;
wherein the first module is couple to the second module via at least one cable having four twisted wire pairs.

2. The KVM management system as described in claim 1, wherein the transitional signal is a non-composite synchronization signal, combined with one of red, green, blue video signals from the computer, and transmitted on at least one twisted wire pairs of the cable.

3. The KVM management system as described in claim 1, wherein the transitional signal is a composite synchronization signal, combined with one of red, green, blue video signals from the computer, and transmitted on at least one twisted wire pairs of the cable.

4. The KVM management system as described in claim 1, further comprises a KVM switch apparatus, which couples the first module to the second module, and routes control signals from the console device to the computer.

5. The KVM management system as described in claim 1, wherein the first module comprises a codec for:
decoding the first type of synchronization signal to derive a first positive horizontal synchronization component and a first positive vertical synchronization component; and
encoding the first positive horizontal synchronization component and the first positive vertical synchronization component to derive the transitional signal.

6. The KVM management system as described in claim 1, wherein the second module comprises a codec for:
decoding the transitional signal to derive a second positive horizontal synchronization component and a second positive vertical synchronization component; and
encoding the second positive horizontal synchronization component and the second positive vertical synchronization component to derive the second type of synchronization signal.

7. The KVM management system as described in claim 1, wherein the first group of synchronization signal combinations or the second group of synchronization signal combinations is a group including a positive horizontal synchronization signal plus a positive vertical synchronization signal, a positive horizontal synchronization signal plus a negative vertical synchronization signal, a negative horizontal synchronization signal plus a positive vertical synchronization signal, a negative horizontal synchronization signal plus a negative vertical synchronization signal, a negative composite horizontal and vertical synchronization signal plus a positive vertical synchronization signal, a positive composite horizontal and vertical synchronization signal without vertical synchronization signal, a negative composite horizontal and vertical synchronization signal without vertical synchronization signal, a positive composite horizontal and vertical synchronization signal plus a positive vertical synchronization signal, a negative composite horizontal and vertical synchronization signal plus a negative vertical synchronization signal and a positive composite horizontal and vertical synchronization signal plus a negative vertical synchronization signal.

8. A keyboard-video-mouse (KVM) management system, coupling a computer to a console device having a display, comprising:
a first module, converting a first type of synchronization signal from the computer into a second type of synchronization signal; and
a second module, converting the second type of synchronization signal into a third type of synchronization signal for the display;
wherein the first module is couple to the second module via at least one cable having four twisted wire pairs.

9. The KVM management system as described in claim 8, wherein the first module or the second module is a programmable logic device.

10. The KVM management system as described in claim 8, wherein the second type of synchronization signal is carried on at least one twisted wire pair of the cable.

11. The KVM management system as described in claim 10, further comprising a combining module for combining the second type of synchronization signal and one of red, green and blue video signals from the computer.

12. The KVM management system as described in claim 8, wherein the second type of synchronization signal is a composite synchronization signal, for combining with one of red, green, blue video signals from the computer.

13. The KVM management system as described in claim 8, wherein the second type of synchronization signal is predetermined by adjusting a first register stored in the first module.

14. The KVM management system as described in claim 8, wherein the third type of synchronization signal is predetermined by adjusting a second register stored in the second module.

15. A method of providing an adaptable synchronization signal in a keyboard-video-mouse (KVM) management system, coupling a computer to a display, the method comprising steps of:
(A) converting a first type of synchronization signal selected from a first group of synchronization signal combinations into a transitional signal by a first module; and
(B) converting the transitional signal into a second type of synchronization signal selected from a second group of synchronization signal combinations for the display by a second module.

16. The method as described in claim 15, wherein the step (A) further comprising:
(A1) decoding the first type of synchronization signal to derive a first positive horizontal synchronization component and a first positive vertical synchronization component; and
(A2) encoding the first positive horizontal synchronization component and the first positive vertical synchronization component to derive the transitional signal.

17. The method as described in claim 15, wherein the step (B) further comprising:
(B1) decoding the transitional signal to derive a second positive horizontal synchronization component and a second positive vertical synchronization component; and
(B2) encoding the second positive horizontal synchronization component and the second positive vertical synchronization component to derive the second type of synchronization signal.

18. The method as described in claim 15, wherein transitional signal is carried on at least one pair of wire in an Ethernet network cable.

19. The method as described in claim 15, further comprising a step of adjusting a first register stored in the first module during the step of converting the first type of synchronization signal.

20. The method as described in claim 15, further comprising a step of adjusting second register stored in the second module during the step of converting the transitional signal.
